(19) United States
(12) Patent Application Publication
(10) Pub. No.: US 2024/0430190 A1
(43) Pub. Date: Dec. 26, 2024

(54) Integrative Forensic Analysis and Audit System for Outsourced Managed Services and Network Operations Centers (NOCs) Leveraging Human-AI Collaboration

(71) Applicants: EARL STEVENSON, BULLARD, TX (US); BRANDON JARED STEVENSON, BULLARD, TX (US); DYLAN KYLE STEVENSON, BULLARD, TX (US)

(72) Inventors: EARL STEVENSON, BULLARD, TX (US); BRANDON JARED STEVENSON, BULLARD, TX (US); DYLAN KYLE STEVENSON, BULLARD, TX (US)

(21) Appl. No.: 18/338,251

(22) Filed: Jun. 20, 2023

(51) Int. Cl. H04L 43/00; H04L 41/16

(52) U.S. Cl. CPC H04L 43/14; H04L 41/16

(57) ABSTRACT

This patent discloses a groundbreaking system and method for forensic audits of outsourced Managed Services and Network Operations Centers (NOCs). Uniquely blending the expertise of skilled human auditors with advanced technologies, including Artificial Intelligence (AI), machine learning, and state-of-the-art software platforms, this integrated approach revolutionizes accountability, transparency, and customer experience. With no known process like it anywhere on the planet, this invention empowers organizations with unprecedented control and insight into their outsourced providers. It enables comprehensive evaluation of incidents, outages, SLAs, OLAs, KPIs, and overall customer experience, ensuring compliance with legal norms. By optimizing outsourcing relationships, mitigating risks, and elevating service delivery quality, this pioneering invention significantly transforms auditing practices of the outsourcing industry.

### FIELD OF INVENTION

This non-provisional utility patent application proposes an innovative system for performing in-depth audits in Managed Services and Network Operations Centers (NOCs). This system blends manual procedures carried out by skilled human auditors with state-of-the-art technology, offering unprecedented control and insight to organizations over their outsourced service providers.

Key advancements integrated into this system include:

1. ** Software **: The system incorporates industry-standard auditing software such as ACL, IDEA, AuditBoard, CaseWare, and AI-enhanced tools like MindBridge Ai Auditor to optimize data analysis, automation, and reporting.

2. ** Platforms **: The system is designed to work seamlessly with top cloud platforms such as AWS, Google Cloud, and Microsoft Azure, leveraging their robust data storage, processing, and advanced analytics capabilities.

3. ** AI & Machine Learning **: AI and machine learning techniques are utilized for predictive analytics, anomaly detection, and automatic report generation, increasing the precision and efficiency of audit tasks. The system uses libraries like TensorFlow, PyTorch, and Scikit-learn.

4. ** Architecture **: Modern system architectures, including microservices and containerization (via tools like Docker and Kubernetes), are supported, facilitating the creation of adaptable, scalable, and robust auditing systems.

Moreover, auditors can leverage various manual tools and applications for comprehensive and forensic auditing. These include Microsoft Excel, ACL, IDEA, EnCase Forensic, Autopsy and The Sleuth Kit (TSK), FTK (Forensic Toolkit), and Wireshark. However, their combination with AI and machine learning tools can significantly elevate the audit process by automating routine tasks and delivering deeper, quicker insights.

The innovative aspect of this invention resides in the integration of manual processes with advanced technologies, promising an unprecedented level of control over outsourced providers. It addresses the pressing need for accountability, transparency, and improved customer experience, paving the way for a novel approach to auditing in the context of outsourced Managed Services and Network Operations Centers.

### BACKGROUND OF THE INVENTION

In today's dynamic business landscape, many organizations rely on outsourced Managed Services and Network Operations Centers (NOCs) to effectively manage their networks and customers. These outsourcing arrangements allow companies to leverage specialized expertise, optimize costs, and focus on core business operations. However, the outsourcing industry faces significant challenges concerning transparency and accountability.

To address these challenges, the traditional approach involves deploying skilled human auditors proficient in manual processes and methodologies to perform audits and forensic analyses. However, the growing complexity of networks and systems, the volume of data to be analyzed, and the speed at which changes occur call for a new approach to conducting these audits.

In addition to the manual processes, there is a growing need for auditors to deploy and use the latest and most advanced software, tools, platforms, AI, and architecture to enable more efficient, comprehensive, and precise audits. These may include the use of:
Advanced auditing software like ACL, IDEA, AuditBoard, and CaseWare, enabling auditors to conduct detailed evaluations of outsourced providers' performance, compliance, and customer experience.
AI and machine learning (ML) tools like MindBridge Ai Auditor for predictive analytics, anomaly detection, and automatic report generation, facilitating the identification of discrepancies and inefficiencies.
Cloud-based platforms such as AWS, Google Cloud, and Microsoft Azure for secure storage, retrieval, and analysis of audit-related information, enhancing data accessibility and collaboration among audit teams.
Open-source libraries such as TensorFlow, PyTorch, and Scikit-learn for implementing AI and ML algorithms, enabling auditors to leverage advanced data analytics and predictive modeling capabilities in their audit processes.

In light of these technological advancements, the invention proposed in this patent application encompasses:
A system for forensic analyses and audits of the performance of outsourced managed services and NOCs, integrating both manual methodologies and the latest software, tools, platforms, AI, and architecture.
The implementation of comparison algorithms leveraging historical performance data and benchmarks to identify discrepancies, inefficiencies, or potential areas of concern.
The deployment of an auditing platform that complements the analyses system, capturing real-time performance metrics for ongoing assessment and evaluation, facilitated by advanced auditing software and AI tools.
Establishing a transparent feedback loop between the outsourcing company and the managed services provider (MSP) to ensure seamless communication and expectation management, supported by the advanced capabilities of AI-enhanced communication platforms.
Encouragement of competitive market analysis for outsourced services, emphasizing value, quality, and continuous improvement, informed by insights generated by AI and ML tools.

By marrying traditional manual processes with cutting-edge technological advancements, the proposed invention represents a significant evolution in the field of audits for outsourced Managed Services and NOCs, effectively addressing the industry's pressing need for increased transparency, accountability, and enhanced customer experience.

### Specification

To implement the invention, a system needs to be designed that allows auditors to deploy and utilize the latest software, tools, platforms, AI, and architecture while also retaining the manual methods for auditing processes. The system should integrate with the existing infrastructure and facilitate real-time data capture and processing from the managed service provider (MSP). Here are the steps to implement the invention:

1. Assess the existing relationship: Evaluate the current relationship between the outsourcing company and the MSP to identify critical performance metrics, quality benchmarks, and communication channels. This assessment will provide a foundation for designing the customized forensic analyses system.

2. Develop a customized forensic analyses system: Create a tailored forensic analyses system that meets the specific needs and priorities of the partnering organizations. Consider relevant metrics, such as quality, security, and delivery benchmarks, when designing the system. The system should accommodate both manual methods and the latest software, tools, platforms, AI, and architecture.

3. Integrate the scrutiny system: Ensure compatibility and minimal disruption to the current operations by integrating the scrutiny system into the existing infrastructure. This integration should allow seamless data transfer and analysis between the outsourcing company and the MSP.

4. Establish protocols for real-time data capture: Set up protocols for capturing and processing real-time data from the MSP's operations. These protocols should ensure secure transmission of information for analysis, protecting the integrity and confidentiality of the data.

5. Implement a feedback loop: Establish a secure and transparent feedback loop between the outsourcing company and the MSP. This feedback loop should encourage regular communication, clarify objectives, address concerns, and facilitate ongoing collaboration.

6. Leverage forensic analyses results and auditing platform: Utilize the results obtained from the forensic analyses system and the auditing platform to analyze and assess the MSP's performance against pre-defined quality, security, and delivery benchmarks. This analysis should provide insights into the MSP's strengths, weaknesses, and areas for improvement.

7. Regularly review system insights: Continuously review system insights to make data-driven decisions and adapt to changes in the MSP's performance. This regular review ensures ongoing alignment between all parties involved and allows for proactive measures to maintain exceptional performance and security.

8. Engage in continuous improvement strategies: Implement continuous improvement strategies by iterating on the forensic analyses and auditing processes as necessary. This iterative approach ensures the system remains effective and provides a competitive market advantage.

By following these steps, the proposed invention enables companies to confidently assess and hold their managed service partners accountable. It empowers companies to make informed decisions about outsourcing partnerships, maximize return on investment, and foster sustainable growth in a competitive landscape.

### System Architecture

The proposed system architecture for conducting forensic analyses and audits of managed services and Network Operations Centers (NOCs) integrates both manual processes and advanced software, tools, platforms, AI, and architecture. It ensures a comprehensive evaluation of outsourced providers while maintaining the ability for auditors to retain and utilize manual methods. The architecture comprises the following components:

1. Human Auditors: Highly skilled auditors with expertise in manual processes and methodologies form a crucial part of the system. They perform comprehensive assessments, gather relevant data, analyze findings, and document audit reports using their expertise and experience.

2. Advanced Software, Tools, Platforms, AI, and Architecture: The system incorporates the latest and most advanced software, tools, platforms, AI, and architecture to augment the auditing process. Here are some examples:
a. Audit Management Software: Specialized audit management software enables streamlined and automated audit-related activities. It facilitates data collection, analysis, and reporting, enhancing efficiency and effectiveness.
b. Data Analytics Tools: Advanced data analytics tools, such as machine learning algorithms and statistical models, are utilized to process and analyze large volumes of audit data. These tools provide valuable insights and help identify patterns, anomalies, and areas for improvement.
c. Monitoring and Alerting Systems: Automated monitoring and alerting systems are employed to track the performance of managed services and NOCs in real-time. These systems can detect deviations from predefined benchmarks, triggering alerts for further investigation.
d. Cloud Computing and Big Data Platforms: Cloud computing and big data platforms provide scalable infrastructure for storing, processing, and analyzing audit data. They enable efficient handling of large datasets and support advanced analytics capabilities.
e. Artificial Intelligence and Machine Learning: AI and machine learning techniques can be applied to automate certain aspects of the auditing process, such as anomaly detection, trend analysis, and predictive modeling. These technologies enhance the accuracy and efficiency of audits.

3. Manual Methods: The system architecture ensures that auditors can retain and deploy manual methods alongside the advanced software, tools, platforms, AI, and architecture. This allows auditors to leverage their expertise, experience, and judgment to perform comprehensive assessments and analyses that go beyond automated processes.

The system architecture also incorporates secure data handling, storage, and retrieval mechanisms to protect the confidentiality and integrity of audit-related information. Encryption protocols, secure communication channels, access controls, and dedicated servers or cloud infrastructure are employed to safeguard audit data throughout the process.

By combining manual processes with advanced technologies, the proposed system architecture enables auditors to conduct comprehensive evaluations of outsourced providers. It empowers auditors to make data-driven decisions, identify areas for improvement, and hold managed service partners accountable for delivering exceptional performance, security, and value to the organization.

### Audit Methodology

The proposed audit methodology combines manual processes with the use of the latest and most advanced software, tools, platforms, AI, and architecture to conduct comprehensive forensic analyses and audits of outsourced Managed Services and Network Operations Centers (NOCs). Auditors have the flexibility to utilize both manual methods and advanced technologies to ensure a thorough evaluation. Here are the steps involved in the audit methodology:

### 1. Initiating the Audit

a. Contractual Obligations: Establish contractual obligations that mandate periodic audits or trigger-specific audits. These obligations ensure the accountability and transparency of outsourced providers.

b. Pre-Audit Planning: Scope the audit, determine necessary resources, and establish access arrangements for data and systems. Define the specific areas to be audited, such as trouble ticket management, incident response procedures, outage handling, disaster recovery steps, SLAs, OLAs, and customer experience.

c. Resource Allocation: Assign auditors with the required expertise and allocate necessary resources, both human and technical, to conduct the audit effectively.

### 2. Implementing the Audit

a. Data Collection: Gather relevant data and information related to the audited areas. Review trouble tickets, incident reports, SLAs, OLAs, customer feedback, and other data sources that provide insights into the performance and compliance of outsourced providers.

b. Performance Evaluation: Assess the performance of outsourced providers based on defined metrics and KPIs. Analyze response times, resolution rates, SLA and OLA adherence, and overall service quality.

c. Compliance Assessment: Evaluate the adherence of outsourced providers to legal, regulatory, and industry standards. Assess the implementation of security protocols, disaster recovery steps, and compliance with applicable regulations and case law.

d. Customer Experience Analysis: Place significant emphasis on evaluating the customer experience. Collect customer feedback, conduct surveys, and analyze customer satisfaction metrics to identify gaps between customer expectations and the actual service delivery.

### 3. Conducting the Audit

a. Documentation of Findings: Thoroughly document audit findings, including discrepancies between customer expectations and the actual service delivery. This documentation serves as the foundation for audit reports, providing insights and recommendations for improvement.

b. Reporting: Compile comprehensive audit reports summarizing the findings, highlighting areas of concern, and providing recommendations for remediation. Share these reports with the audited company and outsourced providers to drive transparency and action.

c. Follow-up Actions: Include provisions for follow-up actions, such as monitoring the implementation of recommended improvements and conducting periodic audits to track progress, ensure ongoing compliance, and drive performance.

By following this audit methodology, organizations can systematically evaluate the performance, compliance, and customer experience of outsourced Managed Services and NOCs. The combination of manual processes and advanced technologies empowers auditors to deliver comprehensive and data-driven audits, leading to transparency, accountability, and continuous improvement in managing networks and meeting customer needs.

### Forensic Analysis Techniques

During the forensic analyses and audits of outsourced Managed Services and Network Operations Centers (NOCs), auditors utilize a combination of manual methods and the latest advanced software, tools, platforms, AI, and architecture. These techniques help evaluate network performance, incident response procedures, security protocols, and compliance with legal requirements. Here are the forensic analysis techniques employed:

### 1. Network Configuration Analysis

Tools: Network configuration management tools, such as Cisco Prime, SolarWinds Network Configuration Manager, or Ansible.
Techniques: Auditors analyze network topology, infrastructure components, access controls, routing protocols, and network segmentation to identify deviations and vulnerabilities.

### 2. Incident Response Procedures Evaluation

Tools: Incident management tools, incident tracking systems, and ticketing systems, such as ServiceNow, JIRA, or Zendesk.
Techniques: Auditors review incident management processes, escalation protocols, incident categorization, root cause analysis, and incident documentation to assess the effectiveness of incident response procedures.

### 3. Security Protocol Assessment

Tools: Network security tools, vulnerability scanners, and penetration testing frameworks, such as Nessus, Qualys, or Metasploit.
Techniques: Auditors examine authentication mechanisms, encryption protocols, access controls, security monitoring, intrusion detection systems, and vulnerability management processes to evaluate the implementation and effectiveness of security protocols.
   4. Compliance with Legal Precedents and Case Law
Tools: Legal research tools, compliance management software, and regulatory compliance databases, such as Westlaw, Thomson Reuters, or Compliance 360.
Techniques: Auditors review relevant regulations, industry-specific standards, legal precedents, and case law to ensure compliance. They assess whether outsourced providers adhere to applicable legal requirements governing network operations and customer data protection.

### 5. Vulnerability Analysis

Tools: Vulnerability scanning tools, penetration testing frameworks, and vulnerability management platforms, such as OpenVAS, Rapid7 Nexpose, or Tenable.io.
Techniques: Auditors use automated vulnerability scanners, conduct manual penetration testing, and analyze the results to identify weaknesses and potential security risks within the network infrastructure, applications, and systems managed by the outsourced providers.

### 6. Risk Assessment

Tools: Risk assessment frameworks, risk management software, and risk analysis methodologies, such as ISO 31000, NIST SP 800-30, or FAIR.
Techniques: Auditors perform risk assessments to identify and evaluate potential threats, assess their impact and likelihood, and determine the overall risk level. This helps prioritize mitigation efforts and develop effective risk management strategies.

### 7. Remediation Strategies

Techniques: Based on the findings from the forensic analysis, auditors provide actionable recommendations for remediation. These strategies address vulnerabilities, mitigate risks, and enhance the performance, security, and compliance of the outsourced services. The recommendations are tailored to the specific needs and requirements of the audited organization.

By employing these forensic analysis techniques, auditors can comprehensively evaluate the performance, security, and compliance of outsourced Managed Services and NOCs. The combination of manual methods and advanced technologies ensures a thorough assessment and enables organizations to enhance their network security, improve incident response procedures, and meet legal and regulatory requirements.

### Compliance and Legal Considerations

In the forensic analyses and audits of outsourced Managed Services and Network Operations Centers (NOCs), auditors utilize both manual processes and the latest advanced software, tools, platforms, AI, and architecture while considering compliance and legal requirements. Here are the key considerations:

### 1. Analysis of Legal Precedents, Case Law, and Compliance Frameworks

Tools: Legal research tools, compliance management software, and regulatory compliance databases, such as Westlaw, Thomson Reuters, or Compliance 360.
Techniques: Auditors conduct an in-depth analysis of legal precedents, case law, and compliance frameworks relevant to managed services and NOCs. They review court decisions, regulatory guidelines, and legal opinions to ensure the audit methodology aligns with established legal standards and practices. Compliance frameworks, such as ISO 27001, PCI DSS, GDPR, HIPAA, or industry-specific standards, are also considered.
   2. Integration of Legal Requirements into the Audit Methodology
Techniques: Auditors integrate legal requirements and compliance considerations into the audit methodology. They define audit criteria and evaluation parameters that align with legal standards and regulations. This includes assessing data protection, privacy, security controls, incident response, and contractual obligations. Auditors examine contractual agreements, SLAs, OLAs, and other relevant documents to verify compliance with legal requirements. They assess the presence of required clauses, data protection measures, and provisions for incident reporting and notification.

### 3. Audit Trails, Data Integrity, and Regulatory Adherence

Techniques: Auditors implement mechanisms to capture and maintain detailed audit trails, ensuring transparency and providing evidence of compliance. They establish secure data handling practices, encryption protocols, and access controls to protect the confidentiality and integrity of audit-related information. Auditors implement procedures to prevent unauthorized access, tampering, or loss of audit data. They verify adherence to regulatory standards, data protection regulations, industry-specific compliance requirements, and relevant contractual obligations. Compliance gaps are identified, documented, and addressed through recommendations and remediation strategies.

By considering compliance and legal requirements throughout the forensic analyses and audits, organizations can ensure adherence to legal standards and regulations, maintain transparency, and meet regulatory obligations. The integration of manual processes and advanced technologies facilitates comprehensive assessments while providing the necessary documentation, data integrity, and audit trails required for compliance and legal considerations.

### Impacts on Customers

In the context of the forensic analyses and audits of outsourced Managed Services and Network Operations Centers (NOCs), the impacts on customers are significant. By utilizing both manual processes and the latest advanced software, tools, platforms, AI, and architecture, auditors can address customer needs and deliver value. Here are the key impacts on customers:

### 1. Examination of the Customer Perspective and Expectations

Techniques: Auditors gather insights into the customer perspective and expectations through surveys, interviews, and feedback analysis. This helps understand customer requirements, priorities, and desired outcomes related to service quality, responsiveness, reliability, and data protection.

### 2. Highlighting the Lack of Transparency and Its Consequences

Techniques: Auditors emphasize the lack of transparency in outsourced Managed Services and NOCs, highlighting the negative consequences it can have on the customer experience. This includes incomplete reporting, limited visibility into service performance, and challenges in assessing compliance with service level agreements. By raising awareness, auditors drive the need for increased transparency and accountability.

### 3. Enhanced Customer Experience

Techniques: The proposed system and methodology aim to enhance the customer experience by addressing the lack of transparency and accountability. Comprehensive forensic analyses and audits provide valuable insights into the performance of outsourced providers and the quality-of-service delivery. This transparency empowers customers with information that enables them to make informed decisions about their outsourcing arrangements.

### 4. Informed Decision-Making

Techniques: By conducting forensic analyses and audits, customers gain objective and comprehensive information about the performance, compliance, and security practices of their outsourced providers. This empowers customers to make informed decisions regarding outsourcing contracts, including selection, retention, and negotiation. They can evaluate service alignment with business goals, identify improvement areas, and ensure providers meet their expectations.

### 5. Better Outcomes

Techniques: The proposed system drives better outcomes for customers by promoting accountability and continuous improvement. Audits identify discrepancies between customer expectations and actual service delivery, enabling targeted remediation efforts. Recommendations provided by auditors help customers and providers address performance gaps, mitigate risks, and enhance overall service quality. This results in improved network management, data protection, incident response, and compliance with regulatory requirements.

By considering the customer perspective, addressing the lack of transparency, empowering informed decision-making, and driving better outcomes, the impacts on customers result in enhanced satisfaction, improved service quality, and increased confidence in outsourced Managed Services and NOCs. Customers can have transparency into the performance of their providers, align services with their needs, and ensure the delivery of high-quality services that meet their expectations.

1. A COMPREHENSIVE SYSTEM FOR CONDUCTING FORENSIC ANALYSES AND AUDITS OF OUTSOURCED MANAGED SERVICES AND NETWORK OPERATIONS CENTERS (NOCS), COMPRISING:
Highly skilled human auditors proficient in manual processes and methodologies, combined with the latest and most advanced auditing software such as ACL, IDEA, AuditBoard, and CaseWare, as well as AI-enhanced tools like MindBridge Ai Auditor, to conduct thorough evaluations of outsourced providers' performance, compliance, and customer experience.
Documentation tools designed to capture audit findings, recommendations, and discrepancies, ensuring comprehensive and organized documentation of the audit process.
Secure databases, facilitated by platforms such as AWS, Google Cloud, and Microsoft Azure, for storing audit data, audit trails, and historical records, enabling efficient storage, retrieval, and analysis of audit-related information.
Advanced AI and Machine Learning (ML) frameworks, leveraging open-source libraries such as TensorFlow, PyTorch, and Scikit-learn, for predictive analytics, anomaly detection, and automatic report generation.

2. A METHOD FOR INITIATING, IMPLEMENTING, AND CONDUCTING FORENSIC ANALYSES AND AUDITS OF OUTSOURCED MANAGED SERVICES AND NOCS, COMPRISING:
Contractual obligations mandating audits and adherence to legal requirements, ensuring that outsourced providers are accountable and transparent in their service delivery.
Pre-audit planning involving scoping, resource allocation, data access arrangements, and establishing the combination of manual and automated processes to be used in the audit.
On-site or remote audit execution, encompassing technical evaluations, compliance assessments, and customer experience analyses, facilitated by a blend of manual processes and the latest software, AI, and ML tools.
Post-audit evaluation and reporting, enabled by both human auditors' insights and the automated generation of reports through AI and ML tools.

3. A COMPUTER-READABLE MEDIUM COMPRISING INSTRUCTIONS FOR IMPLEMENTING THE SYSTEM AND METHODOLOGY AS CLAIMED IN claims 1 AND 2.
The computer-readable medium provides the necessary instructions and software components to implement the comprehensive system for conducting forensic analyses and audits of outsourced Managed Services and NOCs, ensuring a seamless integration of manual processes with advanced software, AI, and ML tools.
CONCLUSION—the claims presented in this patent application cover a comprehensive system and methodology for conducting forensic analyses and audits of outsourced Managed Services and Network Operations Centers (NOCs). The system and method uniquely blend the strengths of highly skilled human auditors and the latest technological advancements, including software, AI, and ML tools, to enhance transparency, accountability, and customer satisfaction in the outsourcing industry. This approach establishes the invention's uniqueness, utility, and potential impact in the rapidly evolving auditing landscape.
